(19) United States
(12) Patent Application Publication
(10) Pub. No.: US 2014/0317364 A1
(43) Pub. Date: Oct. 23, 2014

(54) SYSTEMS AND METHODS FOR DATA BACKUP

(71) Applicant: DELL PRODUCTS L.P., Round Rock, TX (US)

(72) Inventors: Jason A. Shepherd, Austin, TX (US); Sean P. O'Neal, Austin, TX (US)

(73) Assignee: Dell Products L.P., Round Rock, TX (US)

(21) Appl. No.: 13/864,473

(22) Filed: Apr. 17, 2013

(51) Int. Cl. G06F 3/06

(52) U.S. Cl. CPC G06F 3/065; G06F 3/0614; G06F 3/067
USPC 711/162

(57) ABSTRACT

In accordance with embodiments of the present disclosure, an intermediary information handling system for communicatively may be configured to couple an information handling system communicatively coupled to the intermediary information handling system to information handling resources attached to or integral to the intermediary information handling system. The intermediary information handling system may include a processor, a memory communicatively coupled to the processor, a network interface communicatively coupled to the processor, and a backup agent comprising one or more instructions embodied in computer-readable media communicatively coupled to the processor. The instructions may cause causing the processor to, when read and executed by the processor: (i) retrieve data from the information handling system; (ii) store the data to the memory; and (iii) upload the data to a remote storage server coupled to the intermediary information handling system via the network interface.

### TECHNICAL FIELD

The present disclosure relates in general to information handling systems, and more particularly to backing up data stored to a local storage resource of an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often include storage resources upon which data (including operating systems and application programs) are stored. It is desirable to occasionally backup such data to another storage resource separate from the information handling system. Such backing up of data allows for restoration of data in the event of a casualty (e.g., fire, flood, natural disaster, theft, hardware failure, etc.) of the original data. Data may be backed up using numerous approaches.

For example, data may be backed up locally using a local storage device such as an external hard disk drive. Such approach is usually completed using a high-speed connection and generally takes a short amount of time. To illustrate, backing up one terabyte of data over a local External Serial Advanced Technology Attachment (eSATA) bus with a bus rate of 16 Gigabits per second would take approximately 62 seconds. Future incremental updates (e.g., incremental changes or “deltas” from the original backup) would likely be smaller in size and take a practically negligible amount of time. However, one drawback of such local backup is that the backed-up data may remain in physical proximity to the original data, such that the same casualty event (e.g., fire, flood, natural disaster, theft) may destroy or harm both the original data and the backup data.

As another example, data may also be backed up over a network to a remote storage resource (e.g., a cloud-based storage service). However, data rates of network connections are typically orders of magnitude slower than that of local data busses. Thus, backing up of one terabyte of data via a typical Internet connection of one Megabit per second would take 1,000,000 seconds or 277 hours. Backing up the same one terabyte of data via a one Gigabit per second Internet connection would take 16 minutes. During backup operations, some data may be difficult for a user to access or modify, as an operating system may designate a file being copied as “in use” such that the user cannot edit or modify such file. Furthermore, once data has been remotely backed up, retrieval of such data in order to perform restoration may also take a relatively long time. Such time delays and limited access to data during backup operations may serve to discourage users from remotely backing up data even if they appreciate the value of backing up data. Thus, even while subsequent backup operations would require less-time consuming backups of incremental changes to the original data, user reluctance to undertake the initial backup operation may prevent backup operations from even reaching such low-impact portion of the backup process.

### SUMMARY

In accordance with the teachings of the present disclosure, the disadvantages and problems associated with client management of an information handling resource may be reduced or eliminated.

In accordance with embodiments of the present disclosure, an intermediary information handling system for communicatively may be configured to couple an information handling system communicatively coupled to the intermediary information handling system to information handling resources attached to or integral to the intermediary information handling system. The intermediary information handling system may include a processor, a memory communicatively coupled to the processor, a network interface communicatively coupled to the processor, and a backup agent comprising one or more instructions embodied in computer-readable media communicatively coupled to the processor. The instructions may cause causing the processor to, when read and executed by the processor: (i) retrieve data from the information handling system; (ii) store the data to the memory; and (iii) upload the data to a remote storage server coupled to the intermediary information handling system via the network interface.

In accordance with these and other embodiments of the present disclosure, a method may include retrieving, by an intermediary information handling system for communicatively coupling an information handling system communicatively coupled to the docking station to information handling resources attached to or integral to the docking station, data from the information handling system. The method may also include storing the data to a memory of the intermediary information handling system. The method may further include uploading the data to a remote storage server coupled to the intermediary information handling system via a network interface of the intermediary information handling system.

In accordance with these and other embodiments of the present disclosure, an article of manufacture may include a computer readable medium and computer-executable instructions carried on the computer readable medium, the instructions readable by a processor, the instructions, when read and executed, for causing the processor to: (i) retrieve, by an intermediate information handling system for communicatively coupling an information handling system communicatively coupled to the intermediate information handling system to information handling resources attached to or integral to the intermediate information handling system, data from the information handling system; (ii) store the data to a memory of the docking station; and (iii) upload the data to a remote storage server coupled to the intermediate information handling system via a network interface of the intermediate information handling system.

Technical advantages of the present disclosure will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for backing up data from an information handling system, in accordance with certain embodiments of the present disclosure;

FIG. 2 illustrates a flow chart of an example method for backing up data from an information handling system, in accordance with certain embodiments of the present disclosure; and

FIG. 3 illustrates a flow chart of an example method for rebuilding an information handling system from backup data, in accordance with certain embodiments of the present disclosure.

### DETAILED DESCRIPTION

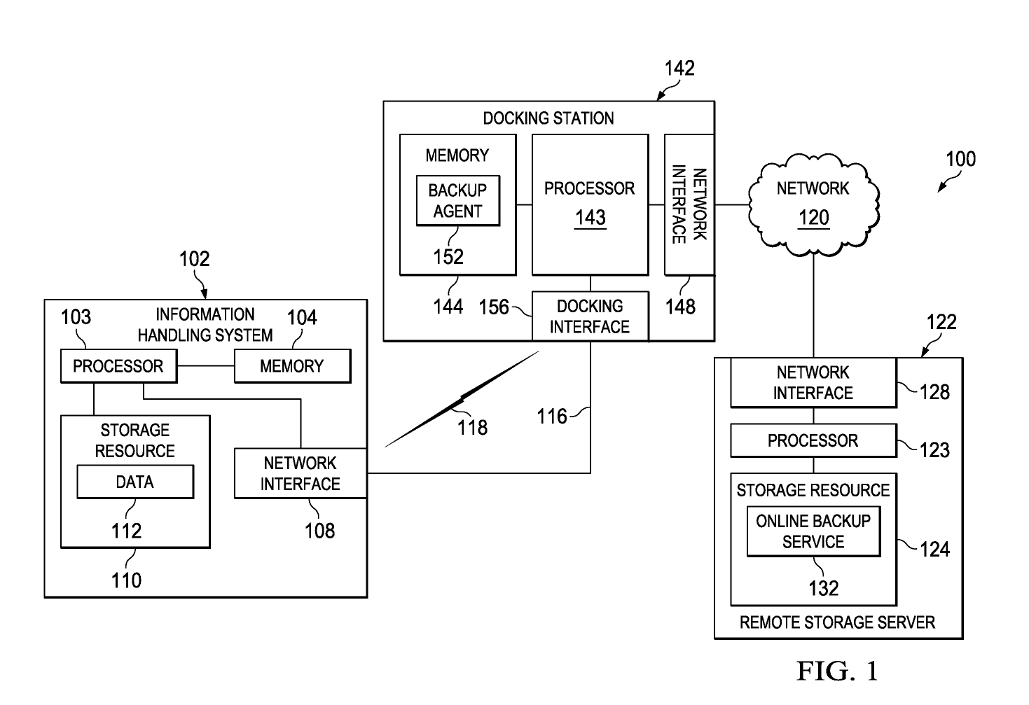

Preferred embodiments and their advantages are best understood by reference to FIGS. 1-3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more busses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, busses, memories, I/O devices and/or interfaces, storage resources, network interfaces, motherboards, and/or any other components and/or elements of an information handling system.

The terms “wireless transmissions” and “wireless communication” may be used to refer to all types of electromagnetic communications which do not require a wire, cable, or other types of conduits. Examples of wireless transmissions which may be used include, but are not limited to, short-range wireless communication technologies (e.g., proximity card, Radio-Frequency Identification (RFID), Near Field Communication (NFC), BLUETOOTH, ISO 14443, ISO 15693, or other suitable standard), IEEE 802.11ad (Wirless Gigabit or “WiGig”), personal area networks (PAN) (e.g., BLUETOOTH), local area networks (LAN), wide area networks (WAN), narrowband personal communications services (PCS), broadband PCS, circuit switched cellular, cellular digital packet data (CDPD), radio frequencies, such as the 800 MHz, 900 MHz, 1.9 GHz and 2.4 GHz bands, infra-red and laser.

The term “wire-line transmissions” may be used to refer to all types of electromagnetic communications over wires, cables, or other types of conduits. Examples of such conduits include, but are not limited to, metal wires and cables made of copper or aluminum, fiber-optic lines, and cables constructed of other metals or composite materials satisfactory for carrying electromagnetic signals. Wire-line transmissions may be conducted in accordance with teachings of the present disclosure over electrical power lines, electrical power distribution systems, building electrical wiring, conventional telephone lines, Ethernet cabling (10baseT, 100baseT, etc.), coaxial cables, T-1 lines, T-3 lines, ISDN lines, ADSL, etc.

FIG. 1 illustrates a block diagram of an example system 100 for backing up data from an information handling system 102, in accordance with certain embodiments of the present disclosure. As shown in FIG. 1, system 100 may include an information handling system 102, a remote storage server 122, and a docking station 142.

In some embodiments, information handling system 102 may be a personal computer. In particular embodiments, information handling system 102 may be a portable information handling system (e.g., a laptop, notebook, tablet, handheld, smart phone, personal digital assistant, etc.). As depicted in FIG. 1, information handling system 102 may include a processor 103, a memory 104 communicatively coupled to processor 103, a network interface 108 communicatively coupled to processor 103, and a storage resource 110 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, storage resource 110, and/or another component of information handling system 102.

Memory 104 may include any system, device, or apparatus configured to retain data (including program instructions) for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

Network interface 108 may comprise any suitable system, apparatus, or device operable to serve as an interface between information handling system 102 and another information handling system and/or network 120. Network interface 108 may enable information handling system 102 to communicate using any suitable transmission protocol and/or standard. In some embodiments, network interface 108 may be configured to communicate with docking interface 156 of docking station 142 via wire-line transmissions 116. In other embodiments, network interface 108 may be configured to communicate with docking interface 156 of docking station 142 via wireless transmissions 118. In these and other embodiments, network interface 108 may comprise a network interface card, or “NIC.”

Storage resource 110 may comprise any system, device, or apparatus configured to persistently retain data 112 (e.g., computer-readable media). Storage resource 110 may include a hard disk drive comprising flash memory, magnetic storage, or any suitable selection and/or array of non-volatile memory that retains data after power to information handling system 102 is turned off.

As shown in FIG. 1, storage resource 110 may have stored thereon data 112. Data 112 may comprise program instructions (e.g., operating systems and software applications), data files (e.g., text, hypertext, formatted text, music files, video files, image files, management data, configuration data), and/or any other digital media that may be stored on a computer-readable medium.

Network 120 may be a network and/or fabric configured to couple remote storage server 122 and docking station 142 to each other and/or one or more other information handling systems. In these and other embodiments, network 120 may include a communication infrastructure, which provides physical connections, and a management layer, which organizes the physical connections and information handling systems communicatively coupled to network 120. Network 120 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 120 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 120 and its various components may be implemented using hardware, software, or any combination thereof.

In some embodiments, remote storage server 122 may be a server. In other embodiments, remote storage server 122 may be a personal computer (e.g., a desktop computer or a portable computer). As depicted in FIG. 1, remote storage server 122 may include a processor 123, a storage resource 124 communicatively coupled to processor 123, and a network interface 128 communicatively coupled to processor 123.

Processor 123 may include any system, device, or apparatus configured to interpret and/or execute program instructions and/or process data, and may include, without limitation, a microprocessor, microcontroller, DSP, ASIC, or any other digital or analog circuitry configured to interpret and/or execute program instructions and/or process data. In some embodiments, processor 123 may interpret and/or execute program instructions and/or process data stored in storage resource 124 and/or another component of remote storage server 122.

Storage resource 124 may comprise any system, device, or apparatus configured to persistently retain data (including program instructions) (e.g., computer-readable media). Storage resource 124 may include one or more hard disk drives comprising flash memory, magnetic storage, or any suitable selection and/or array of non-volatile memory that retains data if power to remote storage server 122 is removed.

As shown in FIG. 1, storage resource 124 may have stored thereon online backup service 132. Online backup service 132 may include any system, device, or apparatus configured to, as described in greater detail elsewhere in this disclosure, manage the receipt and storage of backup data from docking station 142. In some embodiments, online backup service 132 may be implemented as a program of instructions that may be read by and executed on processor 123 to carry out the functionality of online backup service 132.

Network interface 128 may comprise any suitable system, apparatus, or device operable to serve as an interface between remote storage server 122 and network 120. Network interface 128 may enable remote storage server 122 to communicate using any suitable transmission protocol and/or standard, including any of the protocols and/or standards described above with respect to network 120. In these and other embodiments, network interface 128 may comprise a NIC.

In addition to processor 123, storage resource 124, and network interface 128, remote storage server 122 may include one or more other information handling resources.

Docking station 142 may comprise a docking station, port replicator, or dock that allows information handling system 102 or another electronic device to communicatively couple to information handling resources (e.g., keyboard, monitor, mouse, external storage resources, network interfaces, etc.) attached to or integral to docking station 142. As its name indicates, docking station 142 allows information handling system 102 to communicatively couple to docking station 142 (and thus the devices communicatively coupled to docking station 142) via wire-line transmissions 116 and/or wireless transmissions 118 communicated between network interface 108 and docking interface 156. In some embodiments, docking station 142 may comprise an information handling system, albeit with functionality and/or structure different than that of information handling system 102 and/or remote storage server 122. As depicted in FIG. 1, docking station 142 may include a processor 143, a memory 144 communicatively coupled to processor 143, a network interface 148 communicatively coupled to processor 143, and a docking interface 156 communicatively coupled to processor 143.

Processor 143 may include any system, device, or apparatus configured to interpret and/or execute program instructions and/or process data, and may include, without limitation, a microprocessor, microcontroller, DSP, ASIC, or any other digital or analog circuitry configured to interpret and/or execute program instructions and/or process data. In some embodiments, processor 143 may interpret and/or execute program instructions and/or process data stored in memory 144 and/or another component of docking station 142.

Memory 144 may be communicatively coupled to processor 143 and may include any system, device, or apparatus configured to retain program instructions and/or data for a period of time (e.g., computer-readable media). Memory 144 may include RAM, EEPROM, a PCMCIA card, flash memory, magnetic storage, opto-magnetic storage, or any suitable selection and/or array of volatile or non-volatile memory that retains data after power to docking station 142 is turned off. Memory 144 may be either internal or external to docking station 142.

As shown in FIG. 1, memory 144 may have stored thereon backup agent 152. Backup agent 152 may include any system, device, or apparatus configured to, as described in greater detail elsewhere in this disclosure, coordinate backing up of data 112 from information handling system 102 to remote storage server 122 and/or coordinate restoration of data backed up to remote storage server 122 to an information handling system (e.g., information handling system 102). In some embodiments, backup agent 152 may be implemented as a program of instructions that may be read by and executed on processor 143 to carry out the functionality of backup agent 152.

Network interface 148 may comprise any suitable system, apparatus, or device operable to serve as an interface between docking station 142 and network 120. Network interface 148 may enable docking station 142 to communicate using any suitable transmission protocol and/or standard, including any of the protocols and/or standards described above with respect to network 120. In addition, network interface 148 may serve as an interface between network 120 and network interface 108 of information handling system 102 communicatively coupled to docking station 142. In these and other embodiments, network interface 148 may comprise a NIC.

Docking interface 156 may comprise any suitable system, apparatus, or device operable to serve as a communications interface between docking station 142 and network interface 108 of information handling system 102. Docking interface 156 may be configured to communicate with network interface 108 of information handling system 102 via wire-line transmissions 116 and/or wireless transmissions 118.

In addition to processor 143, memory 144, network interface 148, and docking interface 156, docking station 142 may include one or more other information handling resources.

In operation, backup agent 152 may perform an initial local backup of data 112, wherein it receives data 112 from information handling system 102 via wire-line transmissions 116 and/or wireless transmissions 118 and stores such data 112 in memory 144. In some embodiments, backup agent 152 may execute in concert with a corresponding agent (not explicitly shown) executing on processor 103 of information handling system 102 in order to facilitate upload of data 112 from information handling system 102 to docking station 142.

Once data 112 has been backed up to memory 144, backup agent 152 may, based on one or more parameters, determine whether to upload a portion of locally-backed up data 112 to remote storage server 122. Such one or more parameters may include a time of day, volume of network traffic between information handling system 102 and network 120 (e.g., via network interfaces 108 and 148), and/or any other suitable parameters. Such parameters may be indicative of whether a user of information handling system 102 is presently accessing data 112 and/or accessing network 120 via network interface 144. For example, a user may less likely be using information handling system 102 and/or accessing network 120 during certain parts of the day (e.g., during non-business hours), and it may be advantageous to perform transfers of backup data from docking station 142 to remote storage server 122 when a user is not using information handling system 102. As another example, a volume of network traffic between information handling system 102 and network 120 below a particular threshold volume level may indicate that information handling system 102 is not then presently communicatively coupled to or “docked” with docking station 142, meaning information handling system 102 is then unlikely to need to access network 120 via network interface 148, leaving network interface 148 free to communicate backup data from docking station 142 and remote storage server 122 (or vice versa). Such parameters may also be indicative of preferable times to transfer data between docking station 142 and remote storage server 122. For example, some network providers charge more for data transfers occurring at certain times of a day or week compared to other times. Thus, limiting transfers of backup data between docking station 142 and remote storage server 122 to such “off-peak” times may provide cost-efficiency in performing backup operations.

If backup agent 152 determines based on the one or more parameters to upload a portion of the locally backed-up data 112, backup agent 152 may communicate such portion from docking station 142 to remote storage server 122. Upon receipt of a portion of data, online backup service 132 may operate to store such data to storage resource 124 and manage all data stored to remote storage server 122. Backup agent 152 may subsequently upload remaining portions of the locally backed-up data 112 from docking station 142 to remote storage server 122 over time until all of data 112 has been backed up to remote storage server 122.

After the initial transfer of data 112 from information handling system 102 to remote storage server 122, backup agent 152 may then operate to retrieve incremental changes made to data 112, store such incremental changes to memory 142, and then upload such incremental changes to remote storage server 122 at suitable times (e.g., at times based on the one or more parameters discussed above).

In some embodiments, backup agent 152 may perform data deduplication, such that if duplicate data appears within data 112 (e.g., two copies of the same data file) backup agent 152 will store only one copy of such data to remote storage server 122. During such deduplication, backup agent 152 may also store file pointers, such that if an information handling system is rebuilt using data backed up to remote storage server 122, such data will be rebuilt in duplicate as it originally appeared on information handling system 102 from which such data was backed up.

In these and other embodiments, backup agent 152 may also perform data security operations on data as it is uploaded from docking station 142 to remote storage server 122. For example, backup agent 152 may encrypt data as it is uploaded from docking station 142 to remote storage server 122. As another example, system 100 may employ a plurality of remote storage servers 122 and backup agent 152 may distribute different portions of data 112 among various remote storage servers 122 to provide for data security.

Data backed up to remote storage server 122 may be used to rebuild data on an information handling system (e.g., information handling system 102 or a replacement information handling system for information handling system 102). Such rebuild may be performed in response to a casualty affecting data 112 stored on information handling resource 102. When a rebuild occurs, backup agent 152 may at suitable times (e.g., at times based on the one or more parameters discussed above) sequentially download portions of backed-up data to memory 144. Once backup data is downloaded to memory 144, backup agent 152 may copy such data to the information handling system being rebuilt. In some embodiments, such data may be copied to the information handling system being rebuilt as individual portions of the data are received by docking station 142. In other embodiments, such data may be written to the information handling system only after all rebuild data has been downloaded to docking station 142.

In these and other embodiments, docking station 142 may also be configured to cache new data to be stored to information handling system 102. For example, for updates (e.g., patches, upgrades, etc.) to be installed on information handling system 102, docking station 142 may download such updates from a source location (e.g., remote storage server 122 or another server), and then push such update to information handling system 102 when docked to docking station 142.

Although FIG. 1 depicts docking station 142 having backup agent 152 configured to carry out out-of-band communication between remote storage server 122 and information handling system 102, it is understood that any suitable intermediary information handling system (e.g., network switch, router, network attached storage, etc.) capable of executing backup agent 152 may be used in place of docking station 142 depicted in FIG. 1.

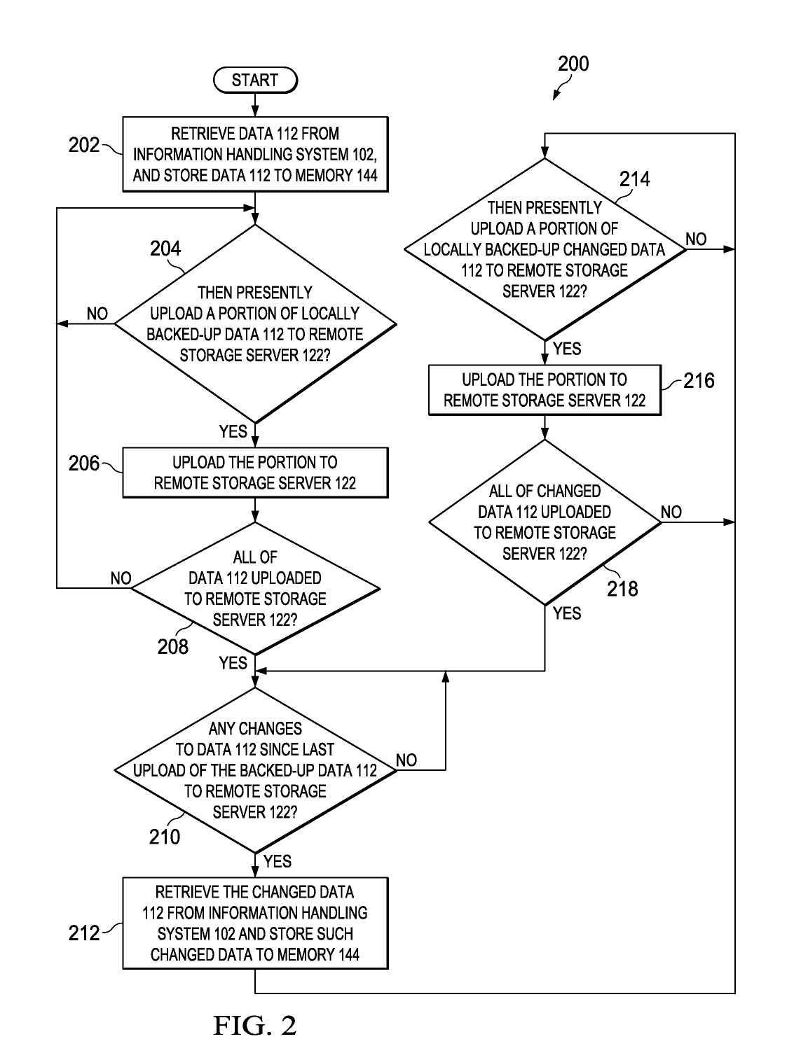

FIG. 2 illustrates a flow chart of an example method 200 for backing up data 112 from an information handling system 102, in accordance with certain embodiments of the present disclosure. According to one embodiment, method 200 may begin at step 202. As noted above, teachings of the present disclosure may be implemented in a variety of configurations of system 100. As such, the preferred initialization point for method 200 and the order of the steps comprising method 200 may depend on the implementation chosen.

At step 202, backup agent 152 may retrieve data 112 from information handling system 102, and store such data to memory 144. Backup agent 152 may retrieve data 112 from information handling system 102 via wire-line transmissions 116 and/or wireless transmissions 118.

At step 204, backup agent 152 may, based on one or more parameters, determine whether to then-presently upload a portion of locally-backed up data 112 to remote storage server 122. Such one or more parameters may include a time of day, volume of network traffic between information handling system 102 and network 120 (e.g., via network interfaces 108 and 148), and/or any other suitable parameters. If backup agent 152 determines to then-presently upload a portion of locally-backed up data 112 to remote storage server 122, method 200 may proceed to step 206. Otherwise, method 200 may remain at step 204 until such time as backup agent 152 determines to then-presently upload a portion of locally-backed up data 112 to remote storage server 122.

At step 206, in response to a determination to then-presently upload a portion of locally-backed up data 112 to remote storage server 122, backup agent 152 may upload the portion to remote storage server 122. During such upload, such data may be deduplicated and/or encrypted.

At step 208, backup agent 152 may determine whether or not all of data 112 has been uploaded to remote storage server 122. If all of data 112 has been uploaded, method 200 may proceed to step 210. Otherwise, method 200 may proceed again to step 204.

At step 210, backup agent 152 may determine whether or not any changes to data 112 have occurred since upload of the backed-up data 112 to remote storage server 122. If changes have occurred, method 200 may proceed to step 212. Otherwise, method 200 may remain at step 210 until changes to data 112 have occurred.

At step 212, backup agent 152 may retrieve the changed data 112 from information handling system 102, and store such changed data to memory 144. Backup agent 152 may retrieve changed data 112 from information handling system 102 via wire-line transmissions 116 and/or wireless transmissions 118.

At step 214, backup agent 152 may, based on one or more parameters, determine whether to then-presently upload a portion of locally-backed up changed data 112 to remote storage server 122. Such one or more parameters may include a time of day, volume of network traffic between information handling system 102 and network 120 (e.g., via network interfaces 108 and 148), and/or any other suitable parameters. If backup agent 152 determines to then-presently upload a portion of locally-backed up changed data 112 to remote storage server 122, method 200 may proceed to step 216. Otherwise, method 200 may remain at step 214 until such time as backup agent 152 determines to then-presently upload a portion of locally-backed up changed data 112 to remote storage server 122.

At step 216, in response to a determination to then-presently upload a portion of locally-backed up changed data 112 to remote storage server 122, backup agent 152 may upload the portion to remote storage server 122. During such upload, such data may be deduplicated and/or encrypted.

At step 218, backup agent 152 may determine whether or not all of changed data 112 has been uploaded to remote storage server 122. If all of changed data 112 has been uploaded, method 200 may proceed again to step 210. Otherwise, method 200 may proceed again to step 214.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using system 100 or any other system operable to implement method 200. In certain embodiments, method 200 may be implemented partially or fully in software and/or firmware embodied in computer-readable media.

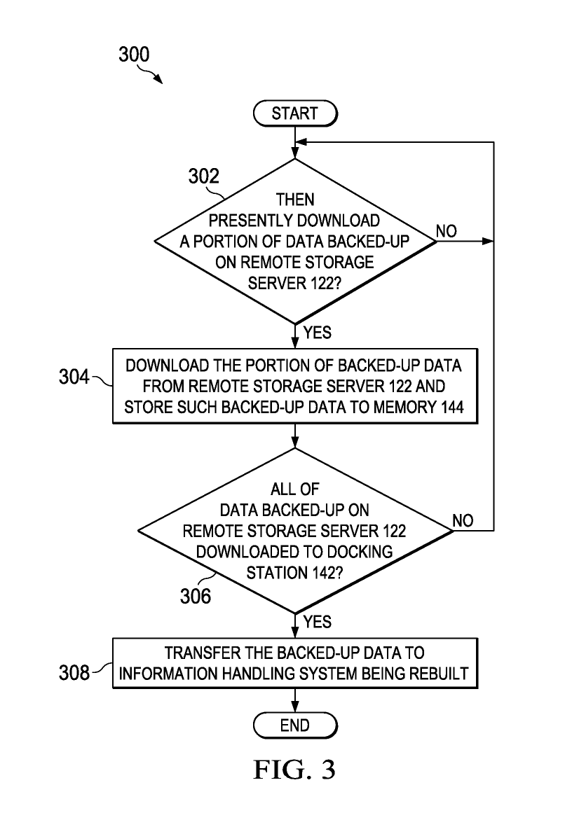

FIG. 3 illustrates a flow chart of an example method 300 for rebuilding an information handling system from backup data, in accordance with certain embodiments of the present disclosure. According to one embodiment, method 300 may begin at step 302. As noted above, teachings of the present disclosure may be implemented in a variety of configurations of system 100. As such, the preferred initialization point for method 300 and the order of the steps comprising method 300 may depend on the implementation chosen.

At step 302, backup agent 152 may, based on one or more parameters, determine whether to then-presently download a portion of data backed up on remote storage server 122. Such one or more parameters may include a time of day, volume of network traffic between information handling system 102 and network 120 (e.g., via network interfaces 108 and 148), and/or any other suitable parameters. If backup agent 152 determines to then-presently download a portion of data backed up on remote storage server 122, method 300 may proceed to step 304. Otherwise, method 300 may remain at step 302 until such time as backup agent 152 determines to then-presently download a portion of data backed up on remote storage server 122.

At step 304, backup agent 152 may download the portion of backed-up data from remote storage server 122, and store such backed-up data to memory 144. During such download, backup agent 152 may decrypt data if such data was stored in encrypted fashion at remote storage server 122.

At step 306, backup agent 152 may determine whether or not all of data backed up on remote storage server 122 has been downloaded to docking station 142. If all of backed up data has been downloaded, method 300 may proceed to step 308. Otherwise, method 300 may proceed again to step 302.

At step 308, backup agent 152 may transfer the backed-up data to an information handling system being rebuilt. After completion of step 308, method 300 may end.

Although FIG. 3 discloses a particular number of steps to be taken with respect to method 300, method 300 may be executed with greater or lesser steps than those depicted in FIG. 3. In addition, although FIG. 3 discloses a certain order of steps to be taken with respect to method 300, the steps comprising method 300 may be completed in any suitable order.

Method 300 may be implemented using system 100 or any other system operable to implement method 300. In certain embodiments, method 300 may be implemented partially or fully in software and/or firmware embodied in computer-readable media.

Although the present disclosure has been described in detail, it should be understood that various changes, substitutions, and alterations can be made hereto without departing from the spirit and the scope of the disclosure as defined by the appended claims.

What is claimed is:

1. An intermediary information handling system for communicatively coupling an information handling system communicatively coupled to the intermediary information handling system to information handling resources attached to or integral to the intermediary information handling system, the intermediary information handling system comprising:
a processor;
a memory communicatively coupled to the processor;
a network interface communicatively coupled to the processor; and
a backup agent comprising one or more instructions embodied in computer-readable media communicatively coupled to the processor, the instructions for causing the processor to, when read and executed by the processor:
retrieve data from the information handling system;
store the data to the memory; and
upload the data to a remote storage server coupled to the intermediary information handling system via the network interface.

2. The intermediary information handling system of claim 1, the backup agent further configured to:
based on one or more parameters, determine whether to then-presently upload a portion of the data from the memory to the remote storage server; and
upload the portion of the data to the remote storage server in response to a determination to then-presently upload a portion of the data from the memory to the remote storage server.

3. The intermediary information handling system of claim 2, wherein the one or more parameters comprises at least one of a time and a volume of traffic through the network interface associated with the information handling system.

4. The intermediary information handling system of claim 2, the backup agent further configured to, responsive to a determination that all of the data stored on the information handling system has been uploaded to the remote storage server and responsive to a determination that changes have been made to the data as stored on the information handling system:
retrieve changed data from the information handling system and store the changed data to the memory; and
upload the changed data to the remote storage server.

5. The intermediary information handling system of claim 1, the backup agent further configured to encrypt the data prior to or during upload of the data to the remote storage server.

6. The intermediary information handling system of claim 1, the backup agent further configured to deduplicate the data prior to or during upload of the data to the remote storage server.

7. The intermediary information handling system of claim 1, wherein the computer-readable medium is the memory.

8. The intermediary information handling system of claim 1, wherein the intermediary information handling system is a docking station.

9. A method comprising:
retrieving, by an intermediary information handling system for communicatively coupling an information handling system communicatively coupled to the docking station to information handling resources attached to or integral to the docking station, data from the information handling system;
storing the data to a memory of the intermediary information handling system; and
uploading the data to a remote storage server coupled to the intermediary information handling system via a network interface of the intermediary information handling system.

10. The method of claim 9, wherein uploading the data to the remote storage server comprises:
based on one or more parameters, determining whether to then-presently upload a portion of the data from the memory to the remote storage server; and
uploading the portion of the data to the remote storage server in response to a determination to then-presently upload a portion of the data from the memory to the remote storage server.

11. The method of claim 10, wherein the one or more parameters comprises at least one of a time and a volume of traffic through the network interface associated with the information handling system.

12. The method of claim 10, further comprising, responsive to a determination that all of the data stored on the information handling system has been uploaded to the remote storage server and responsive to a determination that changes have been made to the data as stored on the information handling system:
retrieving changed data from the information handling system and storing the changed data to the memory; and
uploading the changed data to the remote storage server.

13. The method of claim 9, further comprising encrypting the data prior to or during uploading of the data to the remote storage server.

14. The method of claim 9, further comprising deduplicating the data prior to or during upload of the data to the remote storage server.

15. The method of claim 9, wherein the intermediary information handling system is a docking station.

16. An article of manufacture comprising:
a computer readable medium; and
computer-executable instructions carried on the computer readable medium, the instructions readable by a processor, the instructions, when read and executed, for causing the processor to:
retrieve, by an intermediate information handling system for communicatively coupling an information handling system communicatively coupled to the intermediate information handling system to information handling resources attached to or integral to the intermediate information handling system, data from the information handling system;
store the data to a memory of the docking station; and
upload the data to a remote storage server coupled to the intermediate information handling system via a network interface of the intermediate information handling system.

17. The article of claim 16, the instructions for further causing the processor to:
based on one or more parameters, determine whether to then-presently upload a portion of the data from the memory to the remote storage server; and
upload the portion of the data to the remote storage server in response to a determination to then-presently upload a portion of the data from the memory to the remote storage server.

18. The article of claim 17, wherein the one or more parameters comprises at least one of a time and a volume of traffic through the network interface associated with the information handling system.

19. The article of claim 17, the instructions for further causing the processor to, responsive to a determination that all of the data stored on the information handling system has been uploaded to the remote storage server and responsive to a determination that changes have been made to the data as stored on the information handling system:
retrieve changed data from the information handling system and store the changed data to the memory; and
upload the changed data to the remote storage server.

20. The article of claim 16, the instructions for further causing the processor to encrypt the data prior to or during uploading of the data to the remote storage server.

21. The article of claim 16, the instructions for further causing the processor to deduplicate the data prior to or during upload of the data to the remote storage server.
